(19) United States
(12) Patent Application Publication
(10) Pub. No.: US 2005/0237990 A1
(43) Pub. Date: Oct. 27, 2005

(54) Data transmission method and system

(76) Inventor: Sami Uskela, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/516,993

(22) PCT Filed: Jun. 6, 2003
(86) PCT No.: PCT/FI03/00451

§ 371 Date: Dec. 6, 2004

(30) Foreign Application Priority Data
Jun. 7, 2003 (FI) 20021093

(51) Int. Cl. H04J 3/24

(52) U.S. Cl. 370/349

(57) ABSTRACT

The invention relates to a telecommunication method and system. The system comprises a first and a second unit (100, 120) arranged to communicate with each other using a packet protocol for data transmission. At least some participating units of the transmission are identified with internet protocol addresses. The first and the second unit are arranged to activate a packet data context for data transmission between the units and to associate one packet data context for more than one internet protocol addresses.

### FIELD OF THE INVENTION

The invention relates to data transmission in a telecommunication system employing a packet protocol. Especially the invention can be applied in wireless systems where units participating in transmission are identified with internet addresses.

### RELATED ART

Today telephone systems are also used for implementing various other services than just conventional calls and new service concepts are being continuously designed. Mobile communications systems in particular offer a host of different services. These systems include the packet-switched GPRS system. The services are popular among users because most users always carry their mobile phones with them and thus the services are always available. Mobile phones can be used to access different Internet services that are used either directly by means of the phone, or by means of terminal equipment connected to the phone.

An Internet connection is usually set up by a mobile phone which opens an access connection to an Internet service, after which data can be transmitted in both directions. A server connected to the Internet network is able to communicate with the mobile phone or terminal equipment connected to the network, thus having an IP (Internet Protocol) address, on the basis of which it can be identified and to which the data transmission can be directed. In addition to the IP address, a packet data context is a relevant part of data transmission in packet data networks. In the GPRS network, to be able to transmit and/or receive data, the mobile phone must first activate a Packet Data Protocol Context (PDPC) that it wishes to use. This context is created between the mobile phone and a Gateway GPRS Support Node (GGSN). The gateway node is responsible for routing traffic between the GPRS backbone network and external networks, such as the Internet.

In present networks, one packet data context has been associated to one IP address. This causes some problems. A mobile phone can access packet data services either directly or one or more units of terminal equipment can be used to access packet data services through a mobile phone. Each unit of terminal equipment uses its own IP address, so that the data packets can be routed directly to the terminal. Furthermore, the mobile phone requires an IP address of its own. Different applications in the terminal equipment may also need IP addresses of their own. Thus, there are situations, where several packet data contexts have been simultaneously activated for one mobile phone. This complicates the forwarding processes required in the mobile phone and in the support node. Furthermore, there is a limit to how many simultaneous contexts a mobile phone can support. In the GPRS, the limit is eleven packet data contexts per one mobile station.

### BRIEF DESCRIPTION OF THE INVENTION

It is an object of the invention to provide a method and system in which the forwarding of packet data traffic can be more easily realized compared to presents systems. This is achieved by a data transmission method in a telecommunication system, the method comprising: employing a packet protocol for data transmission; identifying at least some participants of the transmission with internet protocol addresses; activating a packet data context for data transmission between participants, transmitting data between participants; associating one packet data context with more than one internet protocol addresses.

The invention also relates to a telecommunication system, comprising: a first and a second unit arranged to communicate with each other using a packet protocol for data transmission; where in at least some participating units of the transmission are identified with internet protocol addresses; the first and the second unit are arranged to activate a packet data context for data transmission between the units, and the first and the second unit (100, 120) are arranged to associate one packet data context for more than one internet protocol addresses.

Preferred embodiments of the invention are described in the dependent claims.

The method and system of the invention provide several advantages. In a preferred embodiment of the invention one packet data context is thus utilized by more than one connection, each with a different IP address. The forwarding of data packets in both the mobile station and in the support node is thus simpler to realize.

In the solution of one preferred embodiment, where services with a different quality of service requirements are simultaneously in use, one packet data context is activated for each quality of service.

### LIST OF THE DRAWINGS

In the following, the invention will be described in greater detail with reference to the preferred embodiments and the accompanying drawings, in which

FIG. 1 shows an example of a data transmission system;

FIG. 2 illustrates the activation of a connection involving a terminal device, and

FIG. 3 illustrates the usage of a packet data context.

### DESCRIPTION OF THE EMBODIMENTS

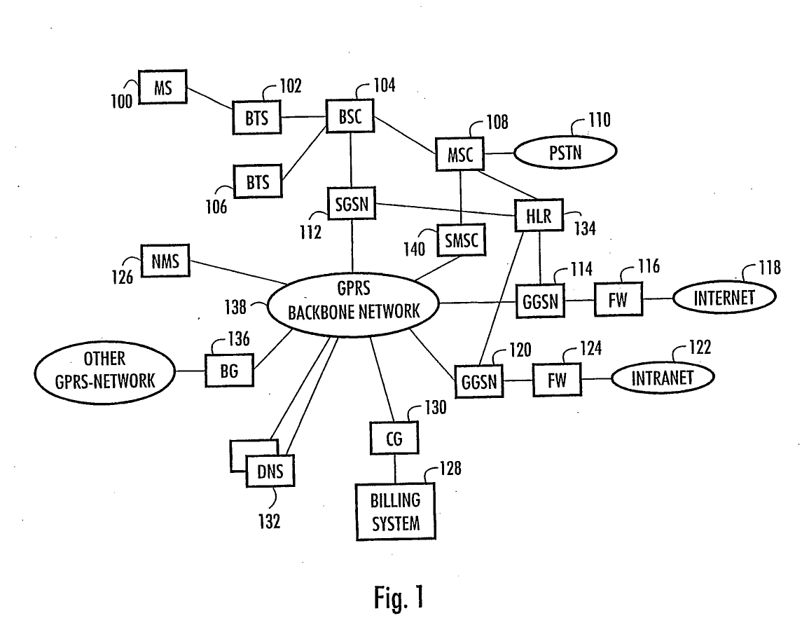

With reference to FIG. 1, examine an example of a data transmission system in which the preferred embodiments of the invention can be applied. FIG. 1 illustrates the structure of a GSM/GPRS (General Packet Radio Service) system. The main elements of the UMTS (Universal Mobile Telecommunications System) are also similar to those of the system disclosed herein. A GRPS terminal device 100 communicates with a Base Transceiver Station (BTS) 102, which in turn communicates with a Base Station Controller (BSC) 104. The base station controller is typically connected to a plural number of base stations 102, 106. The base station controller 104 and the base stations 102, 106 form a Base Station Subsystem (BSS) 160. The base station controller 104 controls the base station 102, 106. The general aim is that the devices that implement the radio path, together with the functionalities associated with them, are located at the base station 102, 106, and the control devices at the base station controller 104.

The base station controller 104 is responsible for example for the management of the radio resources of the base station 102, 106; inter-cell handover operations; frequency management, i.e. the allocation of frequencies to base stations 102, 106; management of frequency hopping sequences; measurement of uplink time delays; implementing an operation and maintenance interface; and management of power control.

The base station 102, 106 comprises at least one transceiver that provides one carrier, i.e. eight time slots or eight physical channels. One base station typically serves one cell, although a solution where one base station serves multiple, sectored cells is also conceivable. The diameter of a cell may vary from a few metres to dozens of kilometres. A part that is also considered to belong to the base station is the transcoder, which carries out the required conversion between the speech-coding format used in the radio system and the one used in the public telephone network. In, practice, however, the transcoder is usually physically located at a mobile services switching centre 108 (to be described below). The base station 102, 106 is responsible for example for carrying out timing advance (TA) computation, uplink measurements, channel coding, encryption, decryption and frequency hopping.

In circuit-switched connections, the base station controller 104 is connected to the Mobile Services Switching Centre (MSC) 108, which is the centre of the circuit-switched side. The mobile services switching centre 108 is responsible for example for providing circuit-switched connections to the public switched telephone network PSTN 110; paging; location registration of a user device; handover management; collecting subscriber billing information; data encryption parameter management; frequency allocation management; and echo cancellation.

In packet-switched connections there is a connection from the base station controller to a Serving GPRS Support Node (SGSN) 112, which is the centre of the packet-switched side. The main function of the serving node 112 is to transmit packets to and receive them from a user terminal device 100 supporting packet-switched transmission. The serving node 112 comprises subscriber and location information relating to user devices 100. The serving node is also responsible for identification.

The GPRS network also comprises a Gateway GPRS Support Node (GGSN) 114. The gateway node 114 is responsible for routing outgoing traffic, possibly through a firewall, from the backbone network to external networks, such as the Internet 118. The network may comprise a plural number of gateway nodes, for example a second gateway node 120 as shown in the example of the Figure, to provide access to an Intranet 122 through a firewall 124.

The system preferably comprises further units responsible for different system maintenance functions. The system typically comprises a Network Management System (NMS) 126 responsible for network management and control. A billing system 128 carries out billing and it communicates with the network over a Billing Gateway (BG) 130. The system further comprises Domain Name Servers (DNS) that maintain lists of the IP addresses in the network and the names associated with them.

A Home Location Register (HLR) 134 comprises a permanent subscriber register, which includes for example the following information: an International Mobile Subscriber Identity (IMSI), Mobile Subscriber ISDN Number (MSISDN), and Authentication Key. The home location register also knows other GPRS parameters, such as Quality of Service (QoS), the allowed access point names of each terminal device, IP address type (dynamic or static), whether GPRS roaming and short messages are allowed through the GPRS network. The serving node SGSN 112 uses these data in Context opening.

A Border Gateway (BG) 136 allows the GPRS networks of different operators to communicate with each other.

The system also comprises a Short Message Service Centre (SMSC) 140, which transmits short messages between the network and the terminal devices.

The GPRS backbone network 138 is typically implemented as a network based on the Internet protocol (IP) for transmitting data between different GPRS network elements.

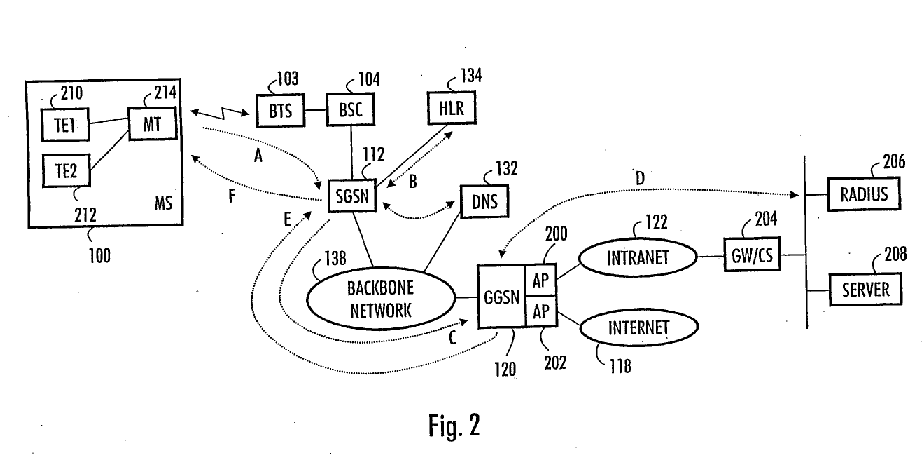

In the GRPS, as well as in other modem networks, terminal devices 100 of several different types may be used. Referring to FIG. 2, a terminal device 100 may comprise, for example, a mobile termination, an MT 214 and one or more terminal equipment units (TE) 210, 212. The connection between the MT and the TE may be called a reference point R. A mobile termination is responsible for the physical connection to the system, transmission of both packet and circuit switched data, signalling between the TE and the system and flow control in the reference point. Terminal equipment is typically a mobile computer or other data processing unit.

From the point of view of the GPRS system, the terminal device 100 may be in any one of three modes known as idle, ready and standby. In the idle mode the terminal device 100 is not registered into the network and the network does not know the SGSN area where, the terminal device is located. Nevertheless, the terminal device may be within the reach of the GSM or UMTS and therefore short messages can be sent and calls set up to it.

If the terminal device 100 wishes to use GPRS services, it carries out a procedure known as a GPRS attach in which a logical connection is set up between the serving node SGSN 112 and the device. This connection is used for authenticating the terminal device, enabling connection ciphering, allocating a temporary identity (TLLI) and copying the user profile from the home location register HLR 134 to the SGSN 112. The network now knows the location of the terminal device with an accuracy of the serving node SGSN. However, no data are transmitted between the terminal device 100 and the node yet, except GPRS control messages. After having completed the GPRS attach, the terminal device is in the ready mode. If the device does not transmit or receive packets for a predetermined period of time, it goes into the standby mode.

To be able to transmit and/or receive data through the GPRS network, the terminal device must first activate the Packet Data Protocol Context (PDPC) that it wishes to use. FIG. 2 illustrates the formation of the PDPC by the terminal device 100. The example assumes that the terminal device 100 wishes to communicate with a server 208, such as a mail server, residing in a company intranet 122.

In the following, let us assume that two TEs 210, 212 are connected to one MT 214. In a situation like this, it is typical, that each TE requires its own IP address. Furthermore, the MT may also require an independent IP address.

In step A the terminal device 100 sends the serving node SGSN 112 an Activate PDP Context Request through the base station 103 and the base station controller 104. The activation request typically comprises information about the required Access Point Name (APN) 200. Access Point refers to a particular interface of the gateway node GGSN providing a connection to a desired external network. The gateway node GGSN typically comprises various access points 200, 202 providing connections to different networks, such as company intranets 122, or, through different operators, to the Internet 118. The activation request typically further comprises information about the PDP type, such as the IP, i.e. the Internet protocol, about the desired quality of service, such as transmission rate, and about the IP address or addresses, if one is known. The activation request may further comprise information that the terminal requires several IP addresses for the PDP context. The terminal device may have fixed IP addresses or the addresses may be determined dynamically for each connection separately.

In step B the serving node SGSN 112 first checks the profile at the home location register HLR 134 to find out whether the desired access point name is allowed, searches the domain name server DNS 134 for the IP address of the gateway node GGSN 120, and maps the APN to the IP address in question.

In step C the serving node SGSN 112 sends a Create PDP Context Request to the gateway node GGSN 120. The request comprises information about the PDP type (such as IP), PDP address, if one is known, the APN, and other parameters, such as information about the desired quality of the connection.

Next, in step D, the GGSN of our example uses the Intranet 122 to contact a RADIUS server 206 of the network in question. The RADIUS (Remote Authentication for Dial-In User Service) server authenticates the terminal device, i.e. checks whether it has access rights to the Intranet and, if dynamic IP addresses are to be used, provides the IP addresses. The IP address may also be retrieved from the internal IP address pool of the gateway node GGSN. A dynamic IP address can also be generated using a DHCP (Dynamic Host Configuration Protocol) server, either within the GGSN or, via the Intranet, within the company in question.

In step E the gateway node GGSN 120 may send a status message to the RADIUS server 206 to inform that the context has been accepted and a Create PDP Context Response to the serving node SGSN 112, which in turn sends an Activate PDP Context Accept to the terminal device 100 in step F. The SGSN can now transmit data between the terminal device 100 and the GGSN 120. The terminal devices may have a plural number of packet data connections open simultaneously.

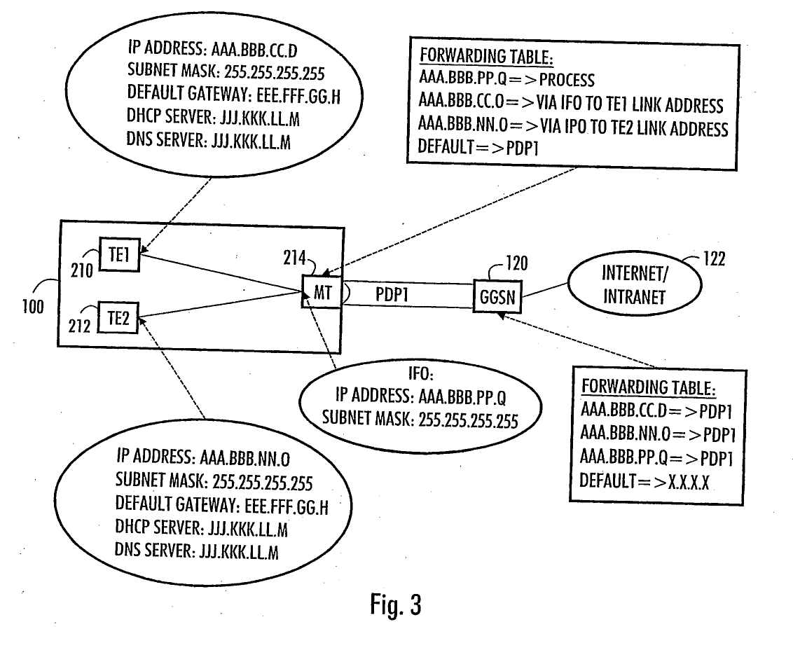

In a preferred embodiment more than one IP addresses are mapped to one packet data context. In the above example three IP addresses were mapped to a PDP context, that is one for each TE and one for MT. For simplicity, in the above example all IP addresses and connections use the same Access Point. This need not be the case generally. Let us study FIG. 3. Two TEs 210, 212 are connected to one MT 214. Each TE and also the MT has its own IP address, as illustrated in FIG. 3. The IP addresses are written as AAA.BBB.CC.D, where the letters in reality correspond to different numbers, as is obvious for one skilled in the art.

MT 214 is connected to the gateway node GGSN 120 by way of one packet data context PDP1. The gateway node GGSN is connected to the Internet/Intranet. The gateway node forwards packets according to the IP addresses of the packets. The node keeps a forwarding table, where each IP address and the respective packet data context are listed. Using the table, the gateway node is able to map IP addresses to the correct PDP context. In this embodiment the forwarding process is simple, as all addresses of a given mobile use the same PDP context.

The MT thus receives packets from the GGSN. Respectively the MT 214 keeps a similar list, where IP addresses are mapped to the correct terminals 210, 212. When the MT has received a packet from the GGSN, it checks the forwarding list which terminal link address corresponds to the terminal with a right IP address and relays the packet. In the opposite transmission direction the MT must forward the packets sent from the terminals 210, 212 to the gateway node 120. In this embodiment the forwarding process in the MT is simple, as all addresses of a given mobile use the same PDP context. In known solutions, each IP address is mapped to a different PDP context, and thus the forwarding process is more complicated.

It is also possible that there are simultaneously active connections with different requirements for the quality of service. The quality of service (QoS) determines how data, such as packet data units, are processed in a telecommunication system during transmission. QoS levels determined for different connections control for example the order in which data units of different connections are transmitted, buffered and rejected in various network elements. Different levels of quality of service thus represent for example various end-to-end delays, bit rates and numbers of lost packet data units.

In another preferred embodiment one packet data context is activated for each quality of service in use. Thus all connections of a mobile station with same the QoS use the same context, and there is thus one PDP context per each QoS in use.

The example illustrated above assumed that two TE 210, 212 were connected to one MT 214. These connections can vary dynamically. It is thus possible that a TE may join or leave an MT while the PDP context is open. If a new connection between a new TE and the MT is set up, the MT transmits a request to the GGSN requesting an internet address to the joined TE. The new address is associated with the existing PDP context, providing the QoS is the same. The forwarding tables kept by the MT and the GGSN are updated accordingly. Respectively when a TE is disconnected from the MT, the MT informs the network and the respective IP address is released.

The disclosed functionalities of the preferred embodiments of the invention can be advantageously implemented by means of software in the mobile station and the different parts of the data transmission system.

Although the invention is described above with reference to an example according to the accompanying drawings, it is obvious that the invention is not restricted to it but may be varied in many ways within the inventive idea disclosed in the accompanying claims.

1. A data transmission method in a telecommunication system, the method comprising:
employing a packet protocol for data transmission;
identifying at least some participants of the transmission with internet protocol addresses;
activating a packet data context for data transmission between participants,
associating one packet data context with more than one internet protocol addresses and
transmitting data between the participants.

2. The method of claim 1, further comprising: activating the packet data context in a mobile station.

3. The method of claim 1, further comprising: identifying one or more units of terminal equipment with unique internet protocol addresses, the terminal equipment being connected to a mobile termination of the mobile station, and identifying the mobile termination with a unique internet protocol address.

4. The method of claim 3, further comprising: the mobile termination sending packet data from more than one internet addresses using one packet data context.

5. The method of claim 3, further comprising: the mobile termination receiving packet data associated with more than one internet addresses, and forwarding each packet to the terminal equipment with the respective internet address.

6. The method of claim 1, further comprising: activating the packet data context between a mobile station and a gateway support node.

7. The method of claim 1, further comprising: transferring data between a mobile station and a gateway support node relating to more than one internet addresses using one packet data context.

8. The method of claim 1, further comprising: activating one packet data context for each quality of service in use.

9. The method of claim 3, further comprising: the mobile termination sending a request to the network for a new internet address, when new terminal equipment is connected to the mobile termination, and associating the internet address with the packet data context.

10. The method of claim 3, by further comprising: the mobile termination sending a request to the network to release the internet address of terminal equipment, when the terminal equipment is disconnected from the mobile termination, and disassociating the internet address from the packet data context.

11. A telecommunication system, comprising:
a first and a second unit arranged to communicate with each other using a packet protocol for data transmission; where in
at least some participating units of the transmission are identified with internet protocol addresses;
the first and the second unit are arranged to activate a packet data context for data transmission between the units, wherein
the first and the second unit are arranged to associate one packet data context for more than one internet protocol addresses.

12. The system of claim 11, wherein the first unit comprises a mobile termination and one or more units of terminal equipment, each identified by a different internet protocol address.

13. The system of claim 12, wherein the second unit is a gateway support node, and that the support node and the mobile termination are arranged to activate a packet data context, and to use the packet data context in the data transmission relating to more than one internet addresses.

14. The system of claim 11, wherein the system is arranged to support connections with a different quality of service, and the first and the second unit are arranged to activate one packet data context for each quality of service.
